(19) United States
(12) Patent Application Publication
(10) Pub. No.: US 2011/0200844 A1
(43) Pub. Date: Aug. 18, 2011

(54) COMPOSITION FOR FACILITATING ENVIRONMENTAL DEGRADATION OF A FILM

(75) Inventors: Todd Michael FAYNE, Dallas, TX (US); Anthony Robert KNOERZER, Parker, TX (US); Kenneth Scott LAVERDURE, Plano, TX (US); Brad Dewayne RODGERS, Frisco, TX (US)

(73) Assignee: FRITO-LAY NORTH AMERICA, INC., Plano, TX (US)

(21) Appl. No.: 12/707,368

(22) Filed: Feb. 17, 2010

(51) Int. Cl. B32B 27/06; B32B 27/00

(52) U.S. Cl. 428/702; 428/411.1

(57) ABSTRACT

A multi-layer PLA film with barrier properties having one or more additives. In one aspect the additive can lower the glass transition temperature of the PLA to enhance the span of environments in which the PLA film can degrade. In one aspect, a plasticizer can be added to lower the glass transition temperature to facilitate degradation at lower temperatures. In one aspect, calcium carbonate can be added to a PLA film layer.

### BACKGROUND OF THE INVENTION

1. Technical Field

The present invention relates to a compostable bio-based flexible packaging material that can be used in packaging products and to a method of making the bio-based packaging material. More specifically it relates to a method and composition for facilitating the degradation of a package made from a multi-layer bio-based flexible film.

2. Description of Related Art

Multi-layered film structures made from petroleum-based products originating from fossil fuels are often used in flexible packages where there is a need for its advantageous barrier, sealant, and graphics-capability properties. Barrier properties in one or more layers are important in order to protect the product inside the package from light, oxygen or moisture. Such a need exists, for example, for the protection of foodstuffs, which may run the risk of flavor loss, staling, or spoilage if insufficient barrier properties are present to prevent transmission of such things as light, oxygen, or moisture into the package. The sealant properties are important in order to enable the flexible package to form an airtight or hermetic seal. Without a hermetic seal, any barrier properties provided by the film are ineffective against oxygen, moisture, or aroma transmission between the product in the package and the outside. A graphics capability is needed because it enables a consumer to quickly identify the product that he or she is seeking to purchase, allows food product manufacturers a way to label the nutritional content of the packaged food, and enables pricing information, such as bar codes, to be placed on the product.

One prior art multi-layer or composite film used for packaging potato chips and like products is illustrated in FIG. 1 which is a schematic of a cross section of the multi-layer film 100 illustrating each individual substantive layer. Each of these layers functions in some way to provide the needed barrier (layer 118), sealant (layer 119), and graphics capability properties. The graphics layer 114 is typically used for the presentation of graphics that can be reverse-printed and viewed through a transparent outer base layer 112. Like numerals are used throughout this description to describe similar or identical parts, unless otherwise indicated. The outer base layer 112 is typically oriented polypropylene (“OPP”) or polyethylene terephthalate (“PET”). A metal layer disposed upon an inner base layer 118 provides the required barrier properties. It has been found and is well-known in the prior art that metalizing a petroleum-based polyolefin such as OPP or PET reduces the moisture and oxygen transmission through the film by approximately three orders of magnitude. Petroleum-based OPP is typically utilized for base layers 112, 118 because of its lower cost. A sealant layer 119 disposed upon the OPP layer 118 enables a hermetic seal to be formed at a temperature lower than the melt temperature of the OPP. A lower melting point sealant layer 119 is desirable because melting the metalized OPP to form a seal could have an adverse effect on the barrier properties. Typical prior art sealant layers 119 include an ethylene-propylene co-polymer and an ethylene-propylene-butene-1 ter-polymer. A glue or laminate layer 115, typically a polyethylene extrusion, is required to adhere the outer base layer 112 with the inner, product-side base layer 118. Thus, at least two base layers of petroleum-based polypropylene are typically required in a composite or multi-layered film.

Other materials used in packaging are typically petroleum-based materials such as polyester, polyolefin extrusions, adhesive laminates, and other such materials, or a layered combination of the above.

FIG. 2 demonstrates schematically the formation of material, in which the OPP layers 112, 118 of the packaging material are separately manufactured, then formed into the final material 100 on an extrusion laminator 200. The OPP layer 112 having graphics 114 previously applied by a known graphics application method such as flexographic or rotogravure is fed from roll 212 while OPP layer 118 is fed from roll 218. At the same time, resin for PE laminate layer 115 is fed into hopper 215a and through extruder 215b, where it will be heated to approximately 600° F. and extruded at die 215c as molten polyethylene 115. This molten polyethylene 115 is extruded at a rate that is congruent with the rate at which the petroleum-based OPP materials 112, 118 are fed, becoming sandwiched between these two materials. The layered material 100 then runs between chill drum 220 and nip roller 230, ensuring that it forms an even layer as it is cooled. The pressure between the laminator rollers is generally set in the range of 0.5 to 5 pounds per linear inch across the width of the material. The large chill drum 220 is made of stainless steel and is cooled to about 50-60° F., so that while the material is cooled quickly, no condensation is allowed to form. The smaller nip roller 230 is generally formed of rubber or another resilient material. Note that the layered material 100 remains in contact with the chill drum 220 for a period of time after it has passed through the rollers, to allow time for the resin to cool sufficiently. The material can then be wound into rolls (not specifically shown) for transport to the location where it will be used in packaging. Generally, it is economical to form the material as wide sheets that are then slit using thin slitter knives into the desired width as the material is rolled for shipping.

Once the material is formed and cut into desired widths, it can be loaded into a vertical form, fill, and seal machine to be used in packaging the many products that are packaged using this method. FIG. 3 shows an exemplary vertical form, fill, and seal machine that can be used to package snack foods, such as chips. This drawing is simplified, and does not show the cabinet and support structures that typically surround such a machine, but it demonstrates the working of the machine well. Packaging film 310 is taken from a roll 312 of film and passed through tensioners 314 that keep it taut. The film then passes over a former 316, which directs the film as it forms a vertical tube around a product delivery cylinder 318. This product delivery cylinder 318 normally has either a round or a somewhat oval cross-section. As the tube of packaging material is pulled downward by drive belts 320, the edges of the film are sealed along its length by a vertical sealer 322, forming a back seal 324. The machine then applies a pair of heat-sealing jaws 326 against the tube to form a transverse seal 328. This transverse seal 328 acts as the top seal on the bag 330 below the sealing jaws 326 and the bottom seal on the bag 332 being filled and formed above the jaws 326. After the transverse seal 328 has been formed, a cut is made across the sealed area to separate the finished bag 330 below the seal 328 from the partially completed bag 332 above the seal. The film tube is then pushed downward to draw out another package length. Before the sealing jaws form each transverse seal, the product to be packaged is dropped through the product delivery cylinder 318 and is held within the tube above the transverse seal 328.

Petroleum-based prior art flexible films comprise a relatively small part of the total waste stream produced when compared to other types of packaging. However, because petroleum films are environmentally stable, they have a relatively low rate of degradation. Consequently, such films can survive for long periods of time in a landfill. Another disadvantage of petroleum-based films is that they are made from oil, which many consider to be a limited, non-renewable resource. Consequently, a need exists for a biodegradable or compostable flexible film made from a renewable resource. In one embodiment, such film should be food safe and have the requisite barrier properties to store a low moisture shelf-stable food for an extended period of time without the product staling. The film should have the requisite sealable and coefficient of friction properties that enable it to be used on existing vertical form, fill, and seal machines.

### SUMMARY OF THE INVENTION

The present invention is directed, in one embodiment, towards a multi-layer packaging film comprising an outer layer, an adhesive layer, and a product side layer comprising barrier properties. In one aspect, the outer layer comprises biaxially oriented polylactic acid (“PLA”) film and an additive such as a plasticizer that lowers the glass transition temperature of the PLA film. In one aspect, a plasticizer such as polyethylene glycol is used. In one embodiment, one or more PLA film layers comprises calcium carbonate.

Other aspects, embodiments and features of the invention will become apparent from the following detailed description of the invention when considered in conjunction with the accompanying figures. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE FIGURES

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 depicts a cross-section of an exemplary prior art packaging film;

FIG. 2 depicts the exemplary formation of a prior art packaging film;

FIG. 3 depicts a vertical form, fill, and seal machine that is known in the prior art;

FIG. 4a depicts a magnified schematic cross-section of a hybrid multi-layer packaging film made according to one embodiment of the invention; and

FIG. 4b depicts a magnified schematic cross-section of a bio-based biodegradable multi-layer packaging film made according to one embodiment of the invention;

FIG. 5 depicts a magnified schematic cross-section of a multi-layer packaging film structure made according to one embodiment of the invention; and

FIG. 6 depicts a magnified schematic cross-section of a multi-layer packaging film made according to one embodiment of the invention.

### DETAILED DESCRIPTION

The present invention is directed towards use of a bio-based film as at least one of the film layers in a multi-layer flexible film packaging. As used herein, the term “bio-based film” means a polymer film where at least 80% of the polymer film by weight is derived from a non-petroleum or biorenewable feedstock. In one embodiment, up to about 20% of the bio-based film can comprise a conventional polymer sourced from petroleum.

One problem with PLA plastic films is that such films have poor moisture barrier and oxygen barrier properties. As a result, such films cannot currently be used exclusively in packaging. Further, many bio-based films including PLA are brittle and stiffer than the OPP typically used for flexible film packages. The handling of open containers, such as grocery bags where no barrier is necessary, made exclusively from bio-based films, is therefore relatively noisy as compared to prior art petroleum-based films. However, the inventors have discovered that many of these problems can be minimized or eliminated by using a “hybrid” film.

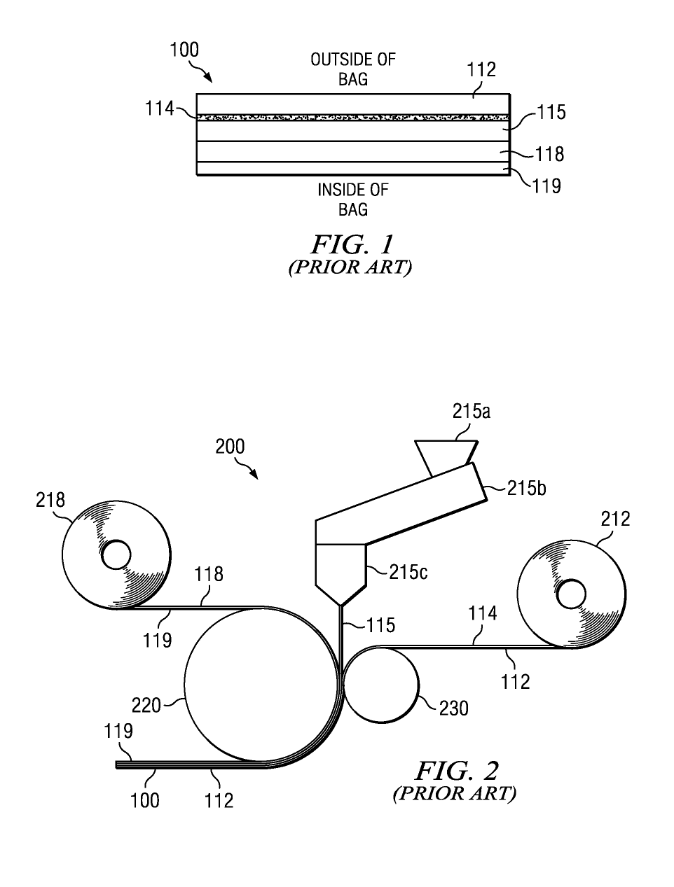

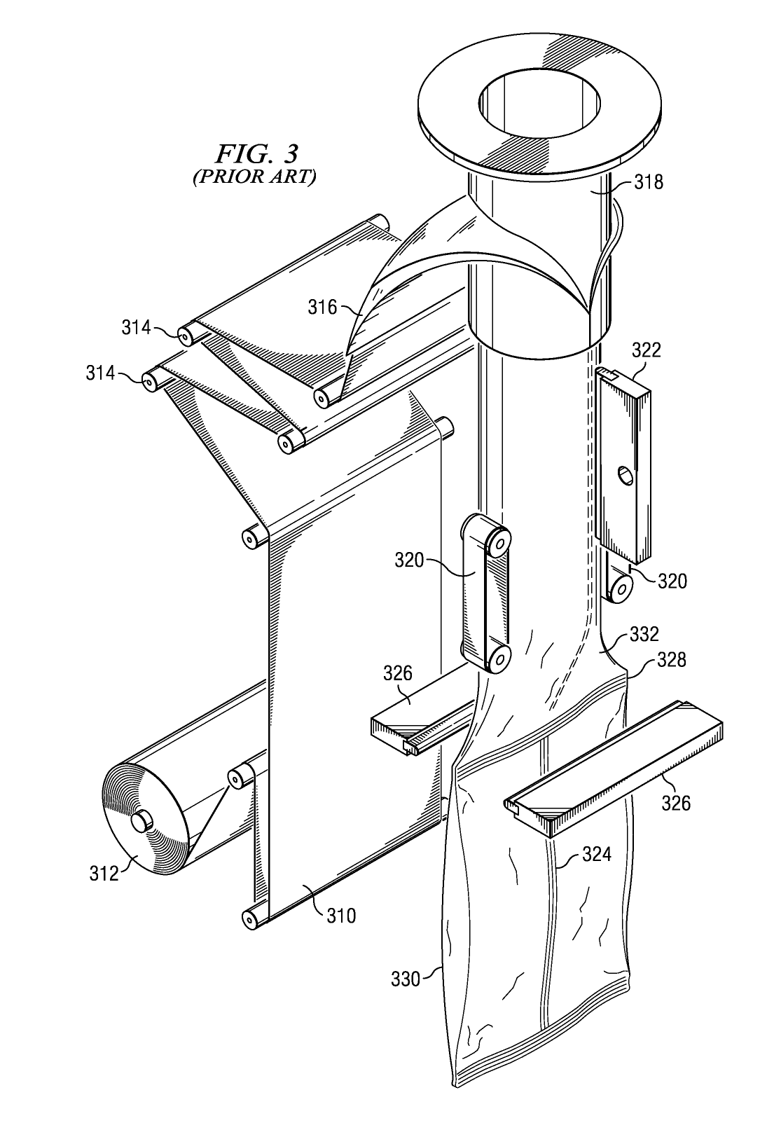

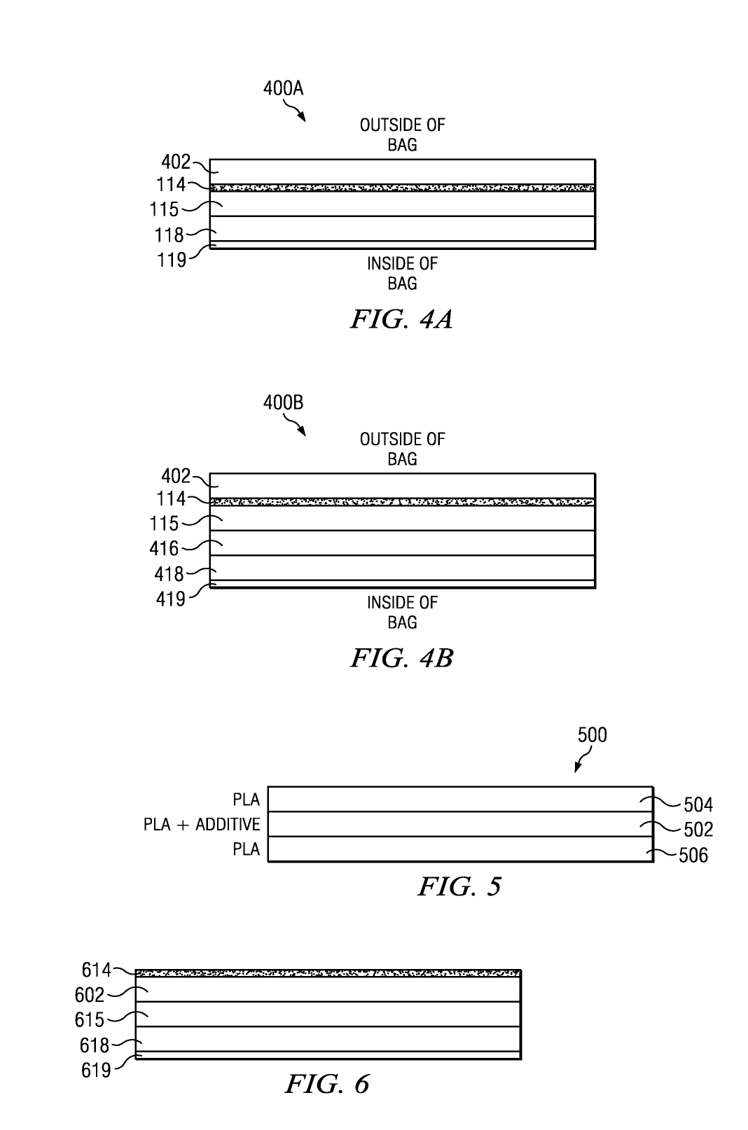

FIG. 4a depicts a magnified schematic cross-section of a hybrid multi-layer packaging film made according to one embodiment of the invention. Here, the outer transparent base layer comprises a bio-based, PLA-based film 402 in place of an oriented petroleum-based polypropylene 112 depicted in FIG. 1. Polylactic acid, also known as polylactide (“PLA”), is a compostable, thermoplastic, aliphatic polyester derived from lactic acid. PLA can be easily produced in a high molecular weight form through ring-opening polymerization of lactide/lactic acid to PLA by use of a catalyst and heat.

PLA can be made from plant-based feedstocks including soybeans, as illustrated by U.S. Patent Application Publication Number 2004/0229327 or from the fermentation of agricultural by-products such as corn starch or other plant-based feedstocks such as corn, wheat, or sugar beets. PLA can be processed like most thermoplastic polymers into a film. PLA has physical properties similar to PET and has excellent clarity. PLA films are described in U.S. Pat. No. 6,207,792 and PLA resins are available from Natureworks LLC (http://www.natureworksllc.com) of Minnetonka, Minn. PLA degrades into carbon dioxide and water. In one embodiment, the bio-based film layer comprises at least about 90% polylactic acid.

The laminate film depicted in FIG. 4a can be made by extruding a biodegradable PLA film 402 into a film sheet. In one embodiment, the PLA film 402 has been oriented in the machine direction or the transverse direction. In one embodiment, the PLA film 402 comprises a biaxially oriented film. In one embodiment, a 120 gauge PLA film 402 is made. A graphic image 114 is reverse printed onto the biodegradable, PLA film 402 by a known graphics application method such as flexographic or rotogravure to form a graphics layer 114. This graphics layer 114 can then be “glued” to the product-side metalized OPP film 118, by a laminate layer 115, typically a polyethylene extrusion. Thus, the prior art OPP outer base layer 112 is replaced with a biodegradable and biorenewable outer base layer 402. In one embodiment, the outer base layer comprises PLA film 402 comprising multiple layers to enhance printing and coefficient of friction properties. In one embodiment, the PLA film 402 comprises one or more layers of PLA.

In the embodiment shown in FIG. 4a, the inside sealant layer 119 can be folded over and then sealed on itself to form a tube having a fin seal for a backseal. The fin seal is accomplished by the application of heat and pressure to the film. Alternatively, a thermal stripe can be provided on the requisite portion of the PLA film 402 to permit a lap seal to be used.

Examples of metalized OPP films 118 having a sealant layer 119 that can be used in accordance with the present invention include PWX-2, PWX-4, PWS-2 films available from Toray Plastics of North Kingstown, R.I. or MU-842, Met HB, or METALLYTE films available from Exxon-Mobil Chemical.

The laminate of film depicted in FIG. 4a is a hybrid film because it comprises both a biodegradable, bio-renewable PLA film 402 and a stable, metalized OPP film 118. However, one benefit of the present invention is that the outer PLA film 402 can be made thicker than prior art outer films to maximize the use of bio-based films 402 and the biodegradability of the overall package while preserving “bag feel” properties that have become so well known to consumers. For example, whereas the prior art outside film 112, laminate layer 115 and inner base layer 118 roughly were each one-third of the package film by weight, in one embodiment, the laminate of the present invention comprises an outside PLA film 402 of 50% by weight, a polyethylene laminate layer 115 being 20% by weight and an inner base OPP layer 118 of about 30% by weight of the total packaging film. Consequently, less OPP film 118 can be used than is required in the prior art, reducing consumption of fossil fuel resources. In one embodiment, the present invention provides a hybrid film having at least about one-quarter less and preferably between about one-third and one-half less fossil fuel-based carbon than a prior art film, yet comprises acceptable barrier properties. As used herein, a film having acceptable oxygen barrier properties has an oxygen transmission rate of less than about 150 cc/m²/day (ASTM D-3985). As used herein, a film having acceptable moisture barrier properties comprises a water vapor transmission rate of less than about 5 grams/m²/day (ASTM F-1249).

There are several advantages provided by the hybrid film depicted in FIG. 4a. First, PLA makes an excellent outer base layer. Unlike polypropylene, PLA has oxygen in the backbone of the molecule. The oxygen inherently provides high surface energy that facilitates ink adhesion. The hybrid film uses 25% to 50% less petroleum than prior art films. The film is also partially compostable, which will be discussed in greater detail below.

FIG. 4b depicts a magnified schematic cross-section of a multi-layer packaging film made according to one embodiment of the invention. Here, the inner base layer comprises a thin metalized barrier/adhesion improving film layer 416 adjacent to a biodegradable or compostable, bio-based film 418 such as PLA instead of an oriented polypropylene 118 depicted in FIG. 1 and FIG. 4a.

A tie layer (not shown) can be disposed between the metalized barrier/adhesion improving film layer 416 and the bio-based film layer 418. A tie layer can permit potentially incompatible layers to be bonded together. The tie layer can be selected from malic anhydride, ethylenemethacrylate (“EMA”), and ethylenevinylacetate (“EVA”).

The metalized barrier/adhesion improving film layer 416 adjacent to the bio-based film 418 can be one or more polymers selected from polypropylene, an ethylene vinyl alcohol (“EVOH”) formula, polyvinyl alcohol (“PVOH”), polyethylene, polyethylene terephthalate, nylon, and a nano-composite coating.

Below depicts EVOH formulas in accordance with various embodiments of the present invention.

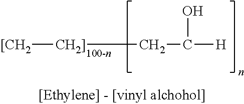

The EVOH formula used in accordance with the present invention can range from a low hydrolysis EVOH to a high hydrolysis EVOH. As used herein a low hydrolysis EVOH corresponds to the above formula wherein n=25. As used herein, a high hydrolysis EVOH corresponds to the above formula wherein n=80. High hydrolysis EVOH provides oxygen barrier properties but is more difficult to process. When metalized, EVOH provides acceptable moisture barrier properties. In one embodiment, the EVOH formula can be coextruded with a bio-based film layer 418 comprising PLA and the EVOH formula can then be metalized by methods known in the art including vacuum deposition.

In one embodiment, the metalized barrier/adhesion improving film layer 416 comprises a metalized PET that is less than about 10 gauge and preferably between about 2 and about 4 gauge in thickness. The PET can be coextruded with the a bio-based film layer 418 comprising PLA and the PET can then be metalized by methods known in the art. In one embodiment, the metalized film 416 comprises a PVOH coating that is applied to the PLA as a liquid and then dried.

In one embodiment, one or both bio-based films 402 418 consists of only PLA. Alternatively, additives can be added to the outer base layer PLA film 402 or the barrier layer bio-based film 418 during the film making process to improve film properties such as the rate of biodegradation.

Effective decomposition of commercial grade PLA requires specific composting conditions. For example, ASTM D 6400 is an industry standard for composting. Effective composting typically requires the material to be subjected to elevated heat, e.g., temperatures greater than ambient, for an extended period of time under relatively high moisture or humidity conditions. Prior art PLA film structures that fail to attain temperatures in excess of 50° C. under moist incubation for several weeks do not decompose or disappear by biological means. This is because commercial grade, non-irradiated PLA is substantially insoluble in water under ambient conditions. Consequently, modern landfills which may provide only anaerobic conditions at or near ambient temperatures fail to provide the environment necessary to degrade prior art PLA films. Further, the degradation of discarded packages that have been dislocated from intended waste streams may not degrade as rapidly as desirable and therefore have the potential to appear as unsightly litter for undesirably prolonged periods of time.

It has been advantageously discovered that lowering the glass transition temperature of a polymer such as PLA enhances the degradation of the PLA under a wider variety of environmental conditions. For example, most commercially produced PLA has a molecular weight of greater than about 250,000 grams per mole. Such high molecular weights are necessary to meet certain mechanical performance requirements. Commercial PLA, such as manufactured by NATUREWORKS, requires a three stage decomposition process—thermal, chemical, and biological.

Regarding the thermal stage, the PLA polymer must first be heated above the glass transition temperature (hereinafter “Tg”) of about 60° C. This physical transformation causes the PLA molecules to become more elastic in nature or rubber-like. At ambient temperature (e.g., temperatures below about 100° F.), PLA is a brittle glass-like solid, similar to “crystal” polystyrene. As the PLA polymer is heated above its Tg, water molecules can diffuse throughout the polymer matrix thereby permitting the second stage of the decomposition process—chemical degradation to begin by hydrolysis of the PLA molecules, which reduces the molecular weight of the commercial prior-art PLA having a molecular weight of 250,000 g/mol to natural PLA having molecular weights ranging from 3600 to 7200 g/mol. The third stage of decomposition occurs as naturally occurring bacteria begin the bio-degradation of PLA into carbon dioxide and biomass.

In a well-managed home compost pile or an industrial compost pile, temperatures easily reach above the Tg of 136° F. (58° C.) for commercial PLA. The elevated temperature is due to thermophilic bacteria. Thermophilic bacteria thrives at higher than ambient temperatures (e.g., temperatures between 38° C. and 80° C. (100° F. and 176° F.), and raises and maintains the temperature of the compost pile as it degrades the PLA. This generated heat, in turn, helps keep the PLA polymers above its Tg.

In one embodiment of the present invention, to make PLA degradable under a wider variety of conditions, the PLA is modified to lower the Tg to thereby provide an enhanced PLA film. As used herein, an enhanced PLA film is a PLA film that has a Tg of between about 10° C. to about 50° C., and more preferably between about 10° C. to about 40° C.

In one embodiment, the enhanced PLA film is made by incorporating a plasticizer into a middle film layer that is bounded by unenhanced PLA film layers. As used herein, an unenhanced PLA film layer is defined as a PLA film layer having a Tg of at least about 58° C. Suitable plasticizers can be defined as compounds having a molecular weight of less than about 10,000 g/mol and more preferably less than about 1,000 g/mol. Plasticizers useful for this invention can include low molecular weight plasticizers and higher molecular weight plasticizers such as oligomeric or polymeric plasticizers. Examples of suitable plasticizers can include poly(ethylene glycols) (“PEG”), poly(propylene glycols), aliphatic polyesters, and poly(vinyl ethyl ether) (PVEE). The plasticizer can be present in an amount of from about 0.1% to about 20%, and more preferably between about 1% and about 5% by weight of the enhanced PLA film layer.

FIG. 5 depicts a magnified schematic cross-section of a multi-layer PLA packaging film structure made according to one embodiment of the invention. As shown in FIG. 5, the PLA film structure 500 is comprised of an enhanced middle PLA layer 502 bounded by a first unenhanced PLA film layer 504 and a second unenhanced PLA film layer 506. When a plasticizer such as PEG is blended into PLA to make an enhanced PLA film layer, the plasticizer lowers both the Tg and the melting point of the PLA. For example, in one embodiment adding between about 1% and about 5% by weight of PEG to the PLA film will lower the Tg of the enhanced PLA film to between about 10° C. and about 50° C.

The two outer layers of unenhanced PLA 504 506 are necessary because lowering the Tg can result in problems during subsequent film processing steps such as film orientation and lamination. Advantageously, the PEG or other plasticizer in the enhanced PLA film layer 502 will diffuse through the layers 504 506 over time to facilitate degradation of the film structure 500 after manufacturing and orientation of the laminate film. In one embodiment each layer 504 506 is at least about 1 to about 10 gauge to permit adequate film processing properties. In one embodiment, the enhanced middle PLA layer 502 is between about 40 gauge and about 120 gauge.

The PLA film structure 500 depicted in FIG. 5 can be used as a print layer and/or as the product side or barrier layer. For example, the bio-based print film layer 402 and/or the bio-based barrier film layer 418 depicted in FIG. 4b can comprise the film structure 500 depicted in FIG. 5. In one embodiment, if the print layer 402 comprises the film structure 500, the film should be printed on within a relatively short period of time (e.g., within about one month) after the film has been made, via co-extrusion, for example and then laminated to the barrier film layer 418 to ensure that the diffusion of the plasticizer does not penetrate or bloom out of the outer layers 504, 506. Similarly, in one embodiment, if the bio-based barrier film layer 418 comprises the film structure 500, and if a plasticizer having a molecular weight of less than about 1,000 g/mol is used in an outer layer 504, 506, the film should have the barrier, which in one embodiment is a metal, applied to the layer within a relatively short period of time (e.g., within about one month) after the film has been made, and then laminated within a relatively short period of time (e.g., within about one month) to the print film layer 402 to ensure that the diffusion of the polyethylene glycol does not penetrate or bloom out of the outer layer and inhibit application of the barrier material. Blooming will not be an issue with plasticizers having a molecular weight of about 1,000 g/mol or greater. In either embodiment, one or both of the outer skin layers 504, 506 can comprise an amorphous PLA to function as a sealant layer 419 to permit a lap seal or a fin seal to be made.

In one embodiment, a film layer comprising PLA further comprises calcium carbonate. Calcium carbonate advantageously creates voids in the PLA film which helps film mechanically break down better and it promotes bacterial growth that facilitates the PLA degradation. Layers 504, 506 comprising PLA and having no plasticizers or calcium carbonate are needed to keep the film structurally viable during the orientation process. In one embodiment, each skin layer 504, 506 is at least about 1 gauge to about 10 gauge to permit adequate film processing properties. In one embodiment, a PLA film layer 502 comprises between about 0.1% to about 50% and more preferably between about 10% and about 40% calcium carbonate by weight of the film layer 502. In one embodiment, the PLA layer 502 having calcium carbonate is between about 40 gauge and 120 gauge.

A PLA film layer comprising calcium carbonate can be used as a print layer and/or as the product side layer. FIG. 6 depicts a magnified schematic cross-section of a multi-layer packaging film made according to one embodiment of the invention. In one embodiment, if the PLA film layer comprising calcium carbonate is used in the outer print layer 602, the graphic image 614 is direct printed on the print layer 602 (instead of reverse printed) because the addition of calcium carbonate adds opacity and cavitation to the film. Consequently, it may be difficult to view graphic images on a reverse-printed film comprising calcium carbonate, depending upon the concentration of the calcium carbonate in the film. An overlacquer well known in the art can then be applied to the graphic image 614 to protect the image.

While calcium carbonate and plasticizers have been specifically described as additives that can facilitate the degradation of a PLA film, Applicants believe other additives can be effectively used as well. Consequently, in one embodiment, where calcium carbonate or plasticizers are disclosed in this application, the disclosure should be construed to include other additives including starch and minerals. As used herein, minerals are normally crystalline chemical compounds and include, but are not limited to diatomaceous earth, clay, feldspar, nepheline syenite, natural and synthetic silica.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

While this invention has been particularly shown and described with reference to a preferred embodiment, it will be understood by those skilled in the art that various changes in form and detail may be made therein without departing from the spirit and scope of the invention.

What is claimed is:

1. A multi-layer packaging film comprising:
a) an outer layer comprising a biaxially oriented PLA film structure wherein said PLA film structure comprises:
a first middle film layer further comprising an enhanced PLA film layer having one or more plasticizers bounded by a first unenhanced PLA film layer and a second unenhanced PLA film layer;
b) an adhesive layer adjacent to said outer layer; and
c) a product side layer comprising barrier properties.

2. The film of claim 1 wherein said plasticizer comprises polyethylene glycol.

3. The film of claim 1 wherein said first middle film layer further comprises calcium carbonate.

4. The film of claim 1 wherein said plasticizer comprises one or more plasticizers selected from polypropylene glycol, aliphatic polyester, and polyvinylethylether.

5. The film of claim 1 wherein said product side layer comprises a second middle film layer further comprising PLA and one or more plasticizers wherein said second middle film layer is bounded by a third unenhanced PLA film layer and a fourth unenhanced PLA film layer.

6. The film of claim 5 wherein said first or said second middle layer comprises between about 1% and about 5% of plasticizer by weight.

7. The film of claim 5 wherein said first or said second middle layer comprises calcium carbonate.

8. The film of claim 1 wherein said plasticizer comprises a molecular weight of at least about 1000 g/mol.

9. The film of claim 1 wherein said plasticizer comprises a molecular weight of less than about 1000 g/mol.

10. A multi-layer packaging film comprising:
a) an outer layer comprising a biaxially oriented PLA film structure wherein said PLA film structure comprises:
a first middle film layer further comprising a PLA film layer having calcium carbonate bounded by a first PLA film layer having no calcium carbonate and a second unenhanced PLA film layer having no calcium carbonate;
b) an adhesive layer adjacent to said outer layer; and
c) a product side layer comprising barrier properties.

11. The film of claim 10 wherein said product side layer comprises a second middle film layer further comprising calcium carbonate wherein said second middle film layer is bounded by a third unenhanced PLA film layer having no calcium carbonate and a fourth unenhanced PLA film layer having no calcium carbonate.

12. The film of claim 11 wherein said first or said second middle PLA film layer comprises between about 0.1% and about 50% of calcium carbonate by weight of said middle PLA layer.

13. The film of claim 11 wherein said first or said second middle PLA film layer comprises between about 10% and about 40% of calcium carbonate by weight of said middle PLA layer.

14. The film of claim 11 wherein said first or said second middle PLA film layer further comprises a plasticizer.

15. The film of claim 14 wherein said plasticizer in said first or said second middle PLA film layer further comprises a molecular weight of at least about 1,000 g/mol.

16. The film of claim 14 wherein said plasticizer in said first or said second middle PLA film layer further comprises a molecular weight of less than about 1,000 g/mol.

17. The film of claim 10 wherein said first middle PLA film layer further comprises a plasticizer.

18. The film of claim 17 wherein said plasticizer comprises a molecular weight of at least about 1,000 g/mol.

19. The film of claim 17 wherein said plasticizer comprises a molecular weight of less than about 1,000 g/mol.

20. The film of claim 10 wherein said first middle PLA film layer comprises between about 0.1% and about 50% of calcium carbonate by weight of said first middle PLA layer.

21. The film of claim 10 wherein said first middle PLA film layer comprises between about 10% and about 40% of calcium carbonate by weight of said first middle PLA layer.

22. The film of claim 10 wherein said first middle layer further comprises between about 1% and about 5% of plasticizer by weight.
